(19) United States
(12) Patent Application Publication
(10) Pub. No.: US 2008/0074046 A1
(43) Pub. Date: Mar. 27, 2008

(54) Electroluminescent Display Apparatus and Methods

(75) Inventors: Adrian H. Kitai, Mississauga (CA); Christopher J. Summers, Dunwoody, GA (US); Brent K. Wagner, Marietta, GA (US); Richard C. Cope, Duluth, GA (US)

Correspondence Address: SUTHERLAND ASBILL & BRENNAN LLP, 999 PEACHTREE STREET, N.E., ATLANTA, GA, 30309, US

(73) Assignee: NANOLUMENS ACQUISITION, INC., Norcross, GA (US)

(21) Appl. No.: 11/535,377

(22) Filed: Sep. 26, 2006

(51) Int. Cl. H01J 1/62; H01J 63/04

(52) U.S. Cl. 313/506

(57) ABSTRACT

The present invention provides apparatus, methods and systems for an electroluminescent (EL) display. An exemplary embodiment of an EL apparatus of the invention is in the form of an EL strip. The EL strip may comprise a Supportive Electrode Strip (SES) adapted to receive an EL stack, and an EL stack deposited thereon. The SES comprises a conductive substrate. The EL stack deposited on the SES to form an EL strip may include several layers. The EL strips may be grouped together to form an EL strip panel. The EL strips may also be electrically connected to form an EL panel and EL panels can be electrically connected to form an EL display. Methods for making and testing such systems and components are also disclosed.

### FIELD OF THE INVENTION

The present invention relates to electroluminescent displays, and more particularly to methods and systems for manufacturing electroluminescent apparatus and flexible electroluminescent displays.

### BACKGROUND OF THE INVENTION

Display devices are available that employ the phenomenon of Electroluminescence (EL), which is the conversion of electrical energy to light by a solid phosphor subjected to an electric field. A type of EL device known as a Thin Film Electroluminescent (TFEL) device has shown the desirable qualities of long life, wide operating temperature range, high contrast, wide viewing angle and high brightness.

TFEL devices typically include a laminate or laminar stack of thin films deposited on a substrate; wherein the laminate comprises an EL phosphor material and an insulating layer sandwiched between a pair of electrode layers. EL laminates are substrate-based devices that are typically manufactured in a “front to rear” method beginning with an optically transparent substrate, such as glass, positioned toward the “front” or viewing portion of a display. The substrate is used to hold the device together and provide a surface upon which to apply additional layers. An optically transparent front electrode layer is then deposited onto the optically transparent substrate, typically by sputtering, and an insulating dielectric layer is then deposited on the transparent electrode layer. A phosphor layer is then deposited onto the dielectric layer and a rear electrode layer is deposited onto the phosphor layer to complete the laminate stack.

An example of the result of this prior art manufacturing process is an EL laminate in the form of a thin, solid-state device, that includes a glass substrate; a front transparent electrode layer of a conducting metal oxide on the glass substrate; a dielectric layer on the conducting metal oxide; a phosphor layer on the dielectric layer; another dielectric layer on the phosphor; and a rear electrode layer on the dielectric layer.

Application of an effective voltage between the two electrode layers produces an electric field of sufficient strength to induce electroluminescence in the phosphor layer. The dielectric layer limits the electric current and power dissipation to prevent damage to the EL device.

In operation, AC voltages in the form of alternating positive and negative voltage pulses are applied between the front and rear electrodes to generate high electric fields in the phosphor layer. Above a threshold voltage, the phosphor layer emits a light pulse generally synchronized with the leading edge of the voltage pulse. Below this critical voltage, the phosphor layer may experience electric fields, but the electric field is not sufficient to generate light in the phosphor layer, and so the EL device is in its dark or off state.

In matrix-addressed TFEL panels the front and rear electrodes discussed above are provided in strips to form orthogonal arrays of rows and columns, for example, the front electrode strips defining columns and the rear electrode strips defining rows, to which voltages are applied by electronic drivers. The intersection of the areas of any one row and any one column incorporating the EL structure constitutes an EL pixel. This is the smallest light emitting element that can be controlled in the EL display.

In designing an EL device, a number of different requirements have to be satisfied by the laminate layers and the interfaces between them. For example, to enhance electroluminescent performance, the dielectric constants of the insulator layer should be high. Standard EL thin film insulators, such as SiO₂, Si₃N₄, Al₂O₃, SiOₓN_{y}, SiAlOₓN_{y} and Ta₂O₅, typically have relative dielectric constants (K) in the range of 3 to 20, and are referred to as low K dielectrics. These dielectrics do not exhibit the properties required to work well in layers adjacent to oxide phosphors, which have high threshold electric fields. A second class of dielectrics, called high K dielectrics includes materials such as SrTiO₃, BaTiO₃, and PbTiO₃ which have relative dielectric constants in the range of 100 to 10,000, and are crystalline with the perovskite structure. While all of these dielectrics exhibit a sufficiently high figure of merit (defined as the product of the breakdown electric field and the relative dielectric constant) to function in the presence of high electric fields, not all of these materials offer sufficient chemical stability and compatibility in the presence of high processing temperatures and/or high electric fields. The high K dielectrics SrTiO₃ and BaTiO₃ have performed well when positioned adjacent to oxide phosphors and have been successfully used in TFEL devices.

Substrates are also of fundamental importance for TFEL devices. As discussed briefly above, a glass substrate is typically used to provide a foundation upon which to deposit TFEL layers. But at temperatures significantly higher than 500° C., glass softens and mechanical deformation occurs due to stresses within the glass. Because some phosphors require processing temperatures greater than 500° C., the use of a glass substrate limits the types of phosphors that can be used in the typical TFEL manufacturing process. For example, while yellow-emitting ZnS:Mn TFEL displays are compatible with glass substrates, many TFEL phosphors require higher processing temperatures, such as blue emitting BaAI₂S₄:Eu, which is typically annealed at 750° C. (Noboru Miura, Mitsuhiro Kawanishi, Hironaga Matsumoto and Ryotaro Nakano, Jpn. J. Appl. Phys. , Vol. 38 (1999) pp. L1291-L1292), and green-emitting Zn₂SiO₅Ge_{0.5}O₄:Mn, which is annealed at 700° C. or more (A. H. Kitai, Y. Zhang, D. Ho, D. V. Stevanovic, Z. Huang, A. Nakua, Oxide Phosphor Green EL Devices on Glass Substrates, SID99 Digest, pp. 596-599).

Substrates other than glass may be used, and Wu in U.S. Pat. No. 5,432,015 teaches the use of ceramic substrates, such as alumina sheets, in conjunction with thick film high K dielectrics to create TFEL devices. The high K dielectrics, typically formed from lead containing materials such as PbTiO₃ and related compounds, are deposited by a combination of screen printing and sol-gel methods to form a film of about 20 μm on metalized alumina substrates. Although these dielectrics offer good breakdown protection due to their thickness, they limit the processing temperature that can be applied to phosphors that are on top of the dielectric layer. Phosphors that require processing temperatures of 700° C. or higher may be contaminated by diffusion from the dielectric formulation of the thick film dielectrics. Also, substrate cost is much higher for ceramics than for glass, particularly for large size ceramics over 30 cm in length or width, since cracking and warping of large ceramic sheets is hard to control.

In addition to high temperature mechanical deformation, a further disadvantage of using glass and similar substrates is the rigidity of the resulting display. While a rigid display may be acceptable in some contexts, such as the display for a desktop personal computer, flexible displays offer many advantages. For example, flexible displays are light weight and rugged, and can be formed into various shapes and sizes, including compact sizes. Furthermore, flexible displays offer safety advantages over rigid displays in vehicle and military contexts. In addition, flexible displays offer manufacturing advantages as the displays may be manufactured using low cost and high volume roll-to-roll processing techniques. Thus, it would also be advantageous to provide a flexible EL display that provides a host of potential benefits, such as reductions in weight and thickness and improved ruggedness which creates opportunities in new markets such as military applications.

A recent breakthrough in the manufacture of flexible EL devices is the development of a Sphere Supported Thin Film Electroluminescent (SSTFEL) device as disclosed in PCT Publication No. WO 2005/024951 to Kitai et al. That reference teaches a flexible EL display in which dielectric spheres are embedded in a flexible electrically conducting substrate. Each of the spherical dielectric particles has a first portion protruding through a top surface of a polymer film substrate and a second portion protruding through the bottom surface of the substrate. An electroluminescent phosphor layer is deposited on the first portion of each spherical dielectric particle and a continuous electrically conductive, substantially transparent electrode layer is located on the top surfaces of the electroluminescent phosphor layer and areas of the flexible electrically insulating substrate located between the top surfaces of the electroluminescent phosphor layer. Likewise, a continuous electrically conductive electrode layer is coated on the second portion of the spherical dielectric particles and areas of the flexible, electrically insulated substrate located between the second portions of the spherical dielectric particles.

While fit for its intended purpose, the SSTFEL device requires new manufacturing techniques for forming, aligning and embedding the dielectric spheres. In addition, the reference teaches the use of dielectric spheres of approximately 40-60 μm so that the spheres protrude through the top and bottom of the polymer film substrate, and the use of a phosphor layer of approximately 0.2-1.5 μm. The resulting display requires an operating voltage of about 200-300 volts.

The drive voltage required to power an EL device is a function of the type and thickness of the phosphor layer and the dielectric layer. Benefits of a lower electric field EL phosphor include lower drive voltages and lower electrical stress on the insulating layer in the EL device. It is well known to those familiar with EL devices that the insulating layer is subjected to electric fields that depend on the electric field required in the phosphor. If the electric field in the insulator layer is reduced, better drive reliability is obtained. The insulator and phosphor layers act as capacitors in series such that the voltage drop across each is related to the relative dielectric constants of the materials and their relative thicknesses. If the voltage necessary for EL operation is decreased in the overall device, then the phosphor layer thickness may be increased, and the capacitance of the EL device will decrease, Thus, it is generally desirable to have an EL device with a low drive voltage. Thinner dielectrics mean that less voltage is wasted in the dielectrics and a larger fraction of the applied voltage drops across the phosphor layer. Additionally, the use of higher dielectric constant insulators means that more of the externally applied voltage is placed on the phosphor. But an increased phosphor thickness that reduces the capacitance requires a higher drive voltage to get the same electric field in the phosphor.

There has also been increasing interest in large displays of sizes over 100 inches. These displays may be employed in a variety of contexts such as billboards, control centers, outdoor displays such as transportation signs, arena scoreboards, movie theatres, etc. But the design and manufacturing techniques of many displays, such as LCD and plasma displays do not lend themselves to scalability of larger displays due to weight, cost, and efficiency issues. Thus, what is also needed is a display that is readily scalable to large sizes.

An additional problem with present displays and manufacturing methods is in the area of quality control. Under current methods it is difficult to test whether the display will properly “light up” until a substantial portion of the manufacturing process is completed which leads to costly quality control techniques and high repair and replacement costs. For example, if a display is tested only after completion and a defect is found, then the repair of the display is more costly, and even if the display is repaired, it will typically be sold on a secondary market at decreased margins. Thus, it would be desirable to provide a display that can be tested early in the manufacturing process.

Furthermore, the phosphors used in prior art displays are moisture-sensitive and are therefore not open-atmosphere-tolerant, thus requiring that the phosphors be protected under glass. Not only does this make the display rigid as discussed above, but the manufacture of some types of displays, such as LCD displays, requires expensive manufacturing techniques, such as clean-room processing techniques.

### SUMMARY OF THE INVENTION

The present invention provides apparatus, methods and systems for an EL display. In exemplary embodiments, the systems and methods herein are directed to an electroluminescent apparatus that eliminates some of the deficiencies of prior art substrate-based displays, an EL apparatus that is scalable and testable prior to incorporation into a display, and a flexible EL display incorporating the EL apparatus

An exemplary embodiment of an EL apparatus of the invention is in the form of an EL strip. The EL strip may comprise a Supportive Electrode Strip (SES) adapted to receive an EL stack, and an EL stack deposited thereon. The SES comprises a conductive substrate. The EL stack deposited on the SES to form an EL strip may include several layers. In one exemplary embodiment, the EL stack comprises a dielectric layer, a phosphor layer atop the dielectric layer, and a transparent electrode layer atop the phosphor layer. The EL strips may be grouped together to form an EL strip panel. The EL strips may also be electrically connected to form an EL panel and EL panels can be electrically connected to form an EL display.

In another exemplary embodiment, a preformed Supportive Electrode Unit (SEU) is provided that includes a plurality SESs upon which EL stacks are deposited to form a plurality of EL strips, the EL strips together forming an EL strip panel. The SEU comprises a conductive substrate providing a foundation upon which EL stacks are deposited and serve as row or column electrodes of a display.

An exemplary method of the invention for making an EL strip comprises providing a Supportive Electrode Strip (SES) comprising a conductive substrate and depositing an EL stack atop the SES to form an EL strip. The step of depositing an EL stack may include providing a dielectric layer on the SES, providing a phosphor layer on the dielectric layer, and providing a conducting layer on the phosphor layer. A particular embodiment of the present invention provides a “back-to-front” manufacturing method for making an EL display using the SESs and EL strips mentioned above. The EL strips may be grouped together to form an EL strip panel. The EL strips may also be electrically connected to form an EL panel and EL panels can be electrically connected to form an EL display.

The present invention also provides means for testing an EL apparatus prior to incorporation in a display. Thus, an exemplary method of the present invention includes providing an EL strip, testing the EL strip for defects, and incorporating the EL strip into a display if the EL strip is not defective. According to a particular embodiment, the step of testing the EL strip may comprise applying a voltage to the EL strip and observing the resulting EL properties of the EL strip. As discussed in more detail below this test may be done prior to the incorporation of the EL strip into a display, thereby allowing for the verification of the properties of the EL strip early in the manufacturing process to prevent the incorporation into the display of a defective EL strip. Similarly, EL strip panels and EL panel which include a plurality of EL strips may be tested.

Embodiments of this invention thus provide a high performance EL display that is flexible, scalable, and easily manufactured. The present invention also provides efficient and cost effective methods for manufacturing a flexible EL display that allows testing of EL performance prior to final assembly, thereby facilitating improved quality control and decreasing manufacturing costs.

### BRIEF DESCRIPTION OF THE DRAWINGS

FIG. 1 shows a display in accordance with an exemplary embodiment of the invention.

FIG. 2 shows an EL strip in accordance with an exemplary embodiment of the invention.

FIG. 3 shows a flow chart of a method for making a display in accordance with an exemplary embodiment of the invention.

FIG. 4 shows a flow chart of a method for making an EL strip in accordance with an exemplary embodiment of the invention.

FIG. 5 shows a cross-sectional view of an EL strip in accordance with an exemplary embodiment of the invention.

FIG. 6 shows a flow chart of a method for making an EL strip in accordance with an exemplary embodiment of the invention.

FIGS. 7A-7F show an method of making an EL strip in accordance with an exemplary embodiment of the invention.

FIG. 8 shows a flow chart of a test method in accordance with an exemplary embodiment of the invention.

FIG. 9 shows a flow chart of a test method in accordance with an exemplary embodiment of the invention.

FIG. 10 shows a flow chart of an exemplary method in accordance with an exemplary embodiment of the invention.

FIGS. 11A-11D show a method in accordance with an exemplary embodiment of the invention.

FIGS. 12A-12D show a method of making an EL display in accordance with an exemplary embodiment of the invention.

FIGS. 13A-13B show an EL strip in accordance with an exemplary embodiment of the invention.

FIGS. 14A-14C show a conductor connector in accordance with an exemplary embodiment of the invention.

FIG. 15 shows a flexible EL display in accordance with an exemplary embodiment of the invention.

FIG. 16 shows a Supportive Electrode Unit in accordance with an exemplary embodiment of the invention.

FIG. 17 shows a flowchart of an exemplary method of the invention.

FIGS. 18A-18J show a method of making an EL panel in accordance with an exemplary embodiment of the invention.

FIGS. 19A-19F show a cross-sectional view on an EL panel in accordance with an exemplary embodiment of the invention.

FIGS. 20A-20F show a method of making a flexible EL display in accordance with an exemplary embodiment of the invention.

FIG. 21 shows an EL strip panel in accordance with an exemplary embodiment of the invention.

FIG. 22 shows an EL strip panel in accordance with an exemplary embodiment of the invention.

### DETAILED DESCRIPTION

Generally speaking, the systems, methods, and apparatus taught herein are directed to an EL apparatus and an improved electroluminescent (EL) display incorporating the EL apparatus. By applying what is taught herein a flexible, rugged, and sealable EL display can be made.

As required, exemplary embodiments of the present invention are disclosed. These embodiments are meant to be examples of various ways of implementing the invention and it will be understood that the invention may be embodied in alternative forms. The figures are not to scale and some features may be exaggerated or minimized to show details of particular elements, while related elements may have been eliminated to prevent obscuring novel aspects. Therefore, specific structural and functional details disclosed herein are not to be interpreted as limiting, but merely as a basis for the claims and as a representative basis for teaching one skilled in the art to variously employ the present invention.

In an exemplary embodiment of the invention, a “back-to-front” manufacturing method is used to form an EL strip adapted for incorporation into an EL display. A Supportive Electrode Strip (SES) is provided upon which an EL stack is deposited to form the EL strip. The EL strip can then be tested and incorporated into a display. In exemplary embodiments, the SES is shown as a molybdenum sheet adapted to receive an EL stack but it is contemplated other materials may be used which have the necessary characteristics. SESs may also be provided in the form of a Support Electrode Unit (SEU) which includes a plurality of spaced apart SESs arranged in a predetermined manner.

Advantages of the EL strip include its ability to be manufactured without a rigid glass substrate, its resulting flexibility, and its ability to withstand high phosphor annealing temperatures. The EL strips can be used to create EL strip panels and EL panels which can be tested prior to their incorporation in a display.

The EL strips also allow for independent processing of different phosphors. For example, an EL strip having an EL stack that includes a green phosphor can be annealed separately and at a different temperature than an EL stack including a red phosphor. These EL strips can then be incorporated into the same display. Furthermore, EL strips can be selected for a display depending upon predetermined characteristics thus allowing EL strips to be manufactured and used in a variety of different displays. Although the EL stacks are described herein in some embodiments as including a single phosphor layer, it is contemplated that multiple phosphors could be applied by masking and sputtering techniques as known in the art. For example, red, green and blue phosphor layers may be applied to form pixels for a color display. The use of moisture-resistant phosphors allows for the use of an open-air manufacturing process.

Embodiments of the present invention also provides a means for readily scaling displays to larger sizes. For example, a plurality of EL strips may be grouped together to form an EL strip panel. In one exemplary embodiment individual EL strips are placed on a flexible receiving polymer to form an EL strip panel. In another embodiment, an SEU is used to process a plurality of SESs into EL strips and to form an EL strip panel. Multiple EL strip panels may be joined to form a continuous strip panel. In an exemplary embodiment the SESs of the EL strip panels are joined to form a continuous EL strip panel of a desired length.

In accordance with embodiments of this invention, a plurality of EL panels may be joined to form an EL display. In one exemplary embodiment the end portions of the SESs of adjacent EL panels are exposed, aligned, and connected to form row electrodes of an aggregate EL display. Similarly, the top electrodes of a plurality of EL panels may be connected to form column electrodes of an aggregate display. In this manner a flexible EL display of a variety of sizes may be formed. A further advantage of embodiments is the ability to readily scale a display by the grouping EL strips to form EL strip panels, connecting EL strips to form EL panels, and joining EL panels to form EL displays of a desired size. The width of the column electrodes of the EL stacks can also be readily changed to adapt to different pixel sizes or segmented to a desired length. Additional advantages and features will become apparent to one of skill in the art from the specification, claims, and drawings.

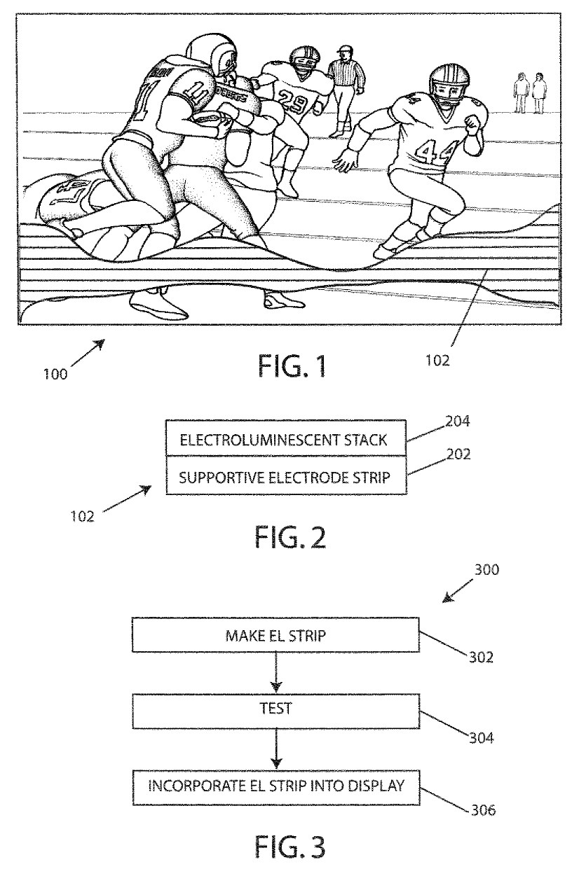

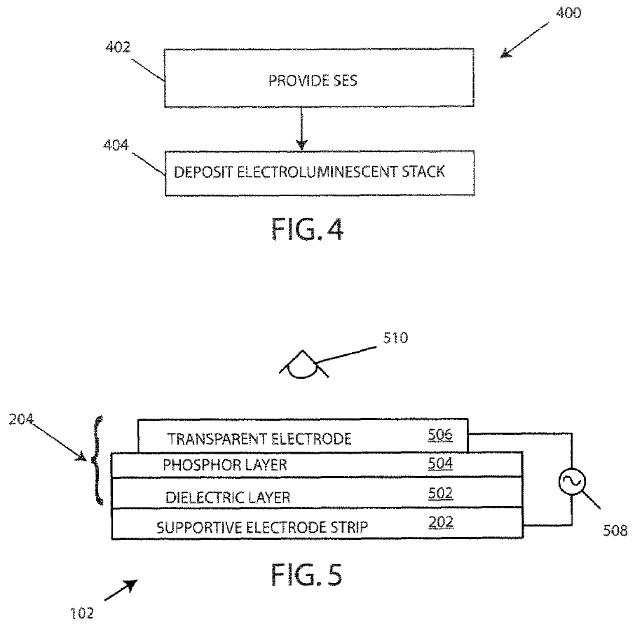

Turning to the drawings wherein like numbers represent like elements throughout the views, FIG. 1 shows an electroluminescent (EL) display 100 incorporating a plurality of EL strips 102 in accordance with one exemplary embodiment of the invention. FIG. 2 shows an exemplary embodiment of an EL strip 102 including a Supportive Electrode Strip (SES) 202 and an EL stack 204 deposited on the SES 202. FIG. 3 shows an exemplary embodiment of a method 300 of manufacturing a display 100, comprising: making an EL strip at block 302, testing the EL strip at block 304, and incorporating the EL strip into a display at block 306. FIG. 4 shows an exemplary method 400 of making the EL strip 102 that includes providing an SES 202 at block 402 and depositing an EL stack 204 atop the SES 202 at block 404.

FIG. 5 shows another exemplary embodiment of an EL strip 102 which comprises the following layers in a “back to front” order with regard to viewing orientation: an SES 202; a dielectric layer 502; a phosphor layer 504; and an optically transparent electrode layer 506. Application of an effective voltage between the SES 202 and the front transparent electrode layer 506 by a voltage source 508 produces an electric field of sufficient strength to induce electroluminescence in the phosphor layer 504. To view the emitted light from the display, a viewer, shown as an eye 510, sees light emitted from the phosphor layer 504 through the transparent electrode layer 506. As will be discussed in more detail below, this arrangement allows the EL strip 102 to be tested prior to incorporation into a display.

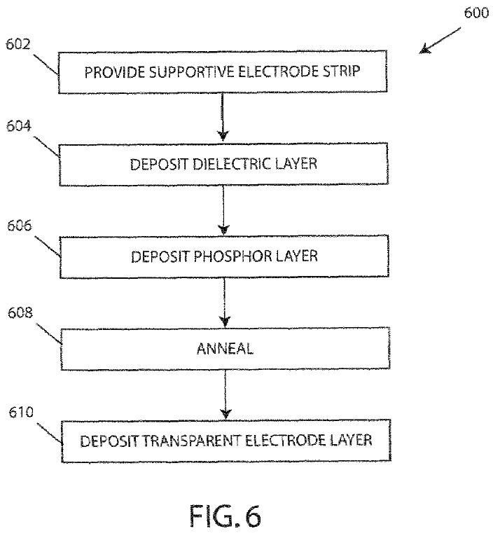

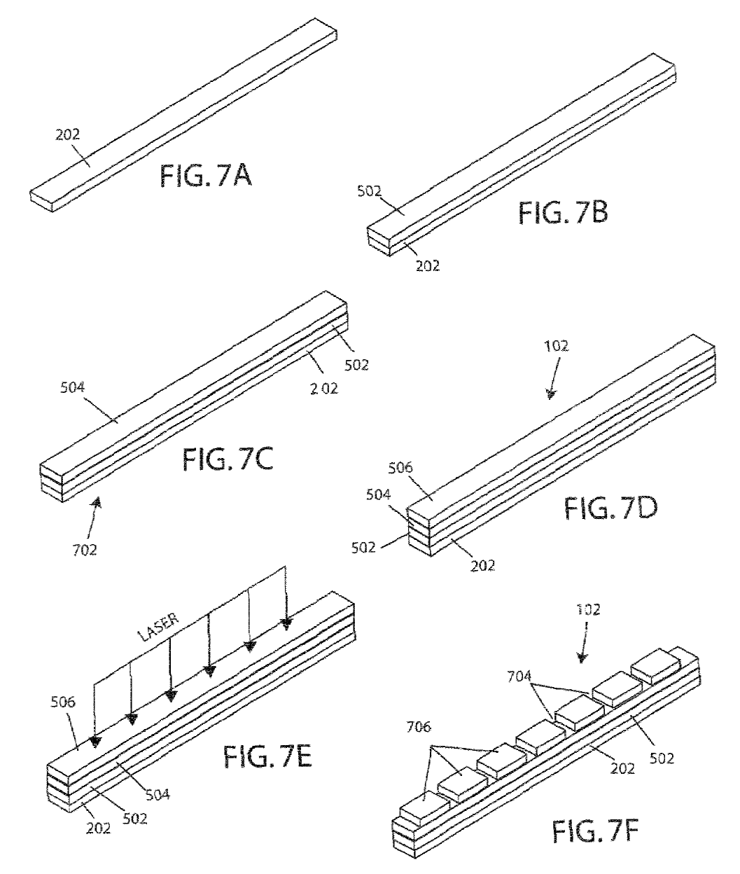

FIG. 6 and FIGS. 7A-7F show a method 600 of making an EL strip 102 in accordance with an exemplary embodiment of the invention. At block 602 an SES 202 is provided. In an exemplary embodiment, the SES 202 (FIG. 7A) may be a flexible 3 mil thick molybdenum sheet having a length corresponding to desired display size and a width corresponding to the desired pixel size. Of course, the dimensions of the SES 202 may vary depending upon the desired characteristics of a resulting display in which the SES 202 will be incorporated. For example, the desired size, flexibility, resolution, and drive voltage of the display may help determine the dimensions and characteristics of the SES 202. According to particular embodiments, the SES 202 desirably is flexible so that the resulting display 100 can be mounted for viewing in conformity with contoured mounting surfaces such as curved walls, has sufficient rigidity to provide sufficient support to receive the EL stack 204 without undue twisting, bending, or collapsing, has an electrical conductivity sufficient for providing sufficient electrical connection to operate the display, and sufficiently low coefficient of thermal expansion such that thermal expansion of the SES during normal operating and handling conditions does not deteriorate the display structure. In an exemplary embodiment, the SES 202 has a surface roughness in the range of less than about 10 nm that allows for the adherence of the EL stack 204 to the SES 202 and a width of 1 mm allows for a [pixel] to be easily incorporated in a 100 inch display providing a high definition resolution display. In addition, molybdenum has a conductivity of around 1.9×10⁷ Siemens/m and rigidity which provides a sufficient support to receive the EL stack 204 without undue twisting, bending, or collapsing.

The SES 202 may be a sheet of conductive metal such as molybdenum, nickel, or aluminum or a combination or alloy thereof and may serve as a row or column electrode in an EL display. The surface of the SES 202 may be polished or planarized to provide the optimum surface characteristics upon which to deposit a functioning EL stack. The particular metal used for the SES 202 is based upon several factors. The first of these is chemical compatibility with the subsequent deposited materials such that no or limited interdiffusion of the constituent elements occurs among the layers compromising their electrical or optical properties. Additionally, the metal should maintain its integrity during subsequent processing steps. For example, if annealing in an oxidizing atmosphere is required the metal must not oxidize to a detrimental extent. Ni is known to produce a nickel oxide layer upon exposure to elevated temperatures in air. If this oxide layer is produced at the Ni/dielectric layer interface it could prove detrimental to device operation depending upon the thickness and electrical properties of the oxide layer. This could be overcome by the use of Ni alloys such as Inconel®, thin metal coatings applied to the Ni, such as molybdenum or gold or the use of more stable materials such as molybdenum. By way of example and not limitation, the SES 202 may be comprised of molybdenum, nickel, aluminum, silver, gold, their alloys, and other conductive materials that possess the above described functional attributes. For the purpose of teaching and not of limitation in the exemplary embodiments discussed in many of the figures, the SES 202 comprises molybdenum, but it will be understood that other materials that have the desired characteristics may be used.

The SES 202 may take several forms. In one exemplary embodiment, the SES 202 may be a sheet of conductive metal in dimensions corresponding to the row or column size of the desired display. The EL strip 102 is formed by depositing an EL stack 104 on each row or column SES 202. In another exemplary embodiment, the SES 202 may be in the form of a large area conductive metal sheet. The EL strip 102 is formed by depositing an EL stack 104 over the entire area of the SES 202 then cutting, for example, by laser, the SES with deposited EL stack into EL strips of the desired size.

The EL stack 104 may be deposited by a variety of techniques such as, by way of example and not limitation, sputtering, laser deposition, printing, or other techniques. Additional exemplary embodiments of the EL stack 104 may include additional layers such as additional dielectric, electrode, and/or phosphor layers. For example, an additional flexible electrode layer may be provided to assist in the flexing of the conductive layer when the apparatus is to be incorporated into a flexible display.

At block 604 a dielectric layer 502 (FIG. 7B) may be provided atop the SES 202. The dielectric layer 502 may be a high dielectric material such as BaTiO₃ that is deposited to a thickness of about 2 μm. The SES 202 may also be held taut to provide a planar surface for deposition of an EL stack 204. In one exemplary embodiment, a layer of BaTiO₃ is applied by sputtering to a thickness of about 2 μm which is significantly less than the dielectric spheres used in the prior art which allows for a decreased drive voltage. Impurities that are commonly incorporated in the BaTiO₃ allow for an increase in the dielectric constant, and changes in temperature dependence and other properties of the dielectric layer. By way of example and not limitation, various thin film dielectrics that may be used in the present invention include SiO₂, SiON, Al₂O₃, BaTiO₃, BaTa₂O₆, SrTiO₃, PbTiO₃, PbNb₂O₆, Sm₂O₃, Ta₂O₅—TiO₂, Y₂O ₃, Si₃N₄,SiAlON, and the like.

At block 606 a phosphor layer 504 may be deposited atop the dielectric layer 502 to form a stack 702 (FIG. 7C). Any known electroluminescent phosphor may be used in this layer. The phosphor layer 504 may comprise moisture- and oxygen-resistant phosphors can be exposed to the open atmosphere thereby eliminating the need for hermetic processing. Such phosphors are described in U.S. Pat. Nos. 5,725,801, 5,897,812, 5,788,882 and WIPO Publication No. WO04/090068A1 to Kitai et al. which are hereby incorporated by reference in their entirety. The phosphor layer 504 may be sputtered to a thickness of about 0.7 μm. The stack 702 may then be annealed at block 608.

After annealing, at block 610 a transparent electrode layer 506 may be deposited atop the phosphor layer 504 to form an EL strip 102 shown in FIG. 7D. For example, indium tin oxide (ITO) may be sputtered. As shown in FIG. 7D the transparent electrode layer 506 may be provided over the entire top surface of the phosphor layer 504 or may be deposited in distinct areas shown as electrode chips 706 (FIG. 7F) using masking or other deposition techniques.

As described in more detail below, when an EL strip 102 is incorporated into a display it may be arranged so that the SES 202 of the EL strip 102 serves as a row electrode of the display. Likewise, the transparent electrode layer 506 may serve as a column electrode of a display. To prevent shorting the transparent electrode layer 506 may be provided in the form of a plurality of electrode chips 706. Thus, as shown in FIG. 7E, a laser may be used to make a plurality of channels 704 in the continuous layer of the transparent electrode 506 to form electrode chips 706 as shown in FIG. 7F. Alternatively, as mentioned above, masks may be used to deposit the transparent electrode in discrete sections on the phosphor layer 504 so that an EL strip 102 takes the form shown in FIG. 7F.

One advantage of the present invention is the ability to make individual EL strips 102 independently so that EL strips 102 with different phosphors can be annealed separately. For example, a first EL strip 102 may include a blue phosphor that can produce a bright blue color. Examples of blue-emitting phosphors that can be deposited include: BaAl₂S₄:Eu, which is typically annealed at 750° C., and SrS:Cu, which is typically annealed at 700° C. A second EL strip 102 may include a green-emitting phosphor such as Zn₂Si_{0.5}Ge_{0.5}O₄Mn, which is annealed at 800° C., and deposited on the dielectric layer 502 or a charge injection layer. In yet a further embodiment, an amber EL strip may be formed by depositing a layer of ZnS:Mn, while a red EL strip can be formed by depositing a layer of Ga₂O₃:Eu (See D. Stodilka, A. H. Kitai, Z. Huang, and K. Cook, SID'00 Digest, 2000, p. 11-13). The phosphor layer 504 can be deposited by magnetron sputtering techniques well-known in the art. In an exemplary embodiment, RF sputtering techniques using argon plasma are used to sputter a phosphor layer of approximately 7000 Å thick. In an alternative embodiment, thermal evaporation can be used to deposit the phosphor layer 504. Each EL strip 102 can then be incorporated into an ELD as discussed in more detail below.

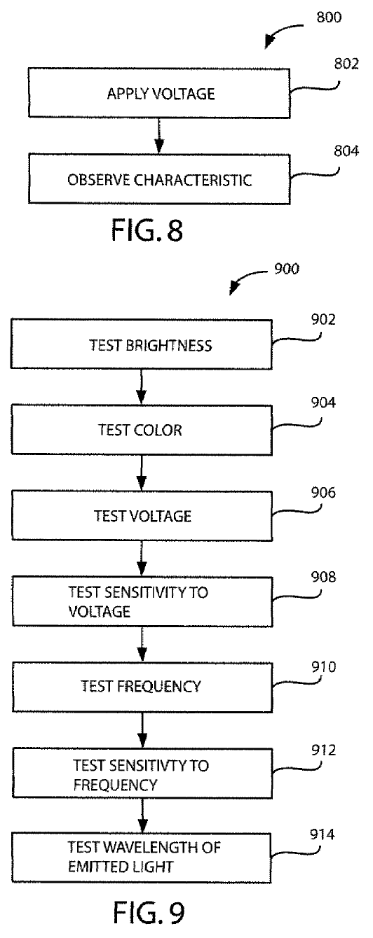

Another advantage of the present invention is the ability to test an EL strip 102, or a plurality of EL strips 102 in the case of an EL strip panel, prior to incorporation into an ELD. FIG. 8 shows an exemplary method 800 of testing an EL strip 102 in which a voltage is applied to the EL strip 102 (FIG. 5) at block 802 to cause electroluminescence. At block 804, the EL strip 102 is observed to determine its characteristics and performance. An operator thus does not have to wait until an ELD has been completely assembled in order to test EL device performance.

As shown in an exemplary method 900 in FIG. 9, individual EL strips 102, can be tested for a variety of characteristics including but not limited to: testing brightness at block 902, testing color point at block 904, testing drive voltage at block 906, testing sensitivity to drive voltage at block 908, testing frequency response at block 910, testing sensitivity to frequency at block 912, and testing the wavelength of emitted light at block 914. Other parameters of interest can also be tested to further characterize the EL strip 102. These test procedures may be automated for increased efficiency.

It is contemplated that after the characteristics of an EL strip 102 have been determined, the EL strip 102 may be categorized in accordance with its characteristics. This allows for unsatisfactory EL strips 102 that perform below a predetermined threshold to be identified and rejected so that they are not incorporated into a display. For example, EL strips 102 with unacceptably low brightness levels can be grouped together and discarded. EL strips 102 that perform within an acceptable range can be retained and grouped according to their characteristics. For example, EL strips 102 with brightness levels ranging from 800 cd/m² to 1000 cd/m² may be put in a first group. EL strips 102 with brightness levels from 600 cd/m² to 800 cd/m² may be put in a second group, and so forth, according to predetermined specifications. By sorting and rejecting individual EL strips 102 based on their characteristics, a manufacturer can improve overall ELD quality as well as production yield by using only those EL strips 102 with proven characteristics for a particular display.

Categorizing EL strips and grouping them accordingly allows a manufacturer to select EL strips of a particular quality or attribute for use in a particular display. Thus, EL strips can be selected for an ELD based on the intended ELD application. For example, an ELD intended for a use as a portable military display may have to satisfy certain flexibility, weight and brightness requirements. Accordingly, EL strips that perform well in a small, thin, flexible ELD structure can be chosen. Both mechanical and electrical attributes may be considered when selecting appropriate EL strips. For example EL strips with high luminosity values may be selected to improve visibility for a portable military display. On the other hand, for large screen ELDs intended for consumer entertainment, color quality and pixel density may be emphasized. Testing and sorting of EL strips 102 facilitates the custom design and manufacture of ELDs in response to application specifications.

Categorizing EL strips 102 also allows a manufacturer to incorporate a group of relatively homogeneous EL strips 102 in a single display. A pixel surrounded by superior pixels can be distracting to the observer, and detrimental to the overall ELD performance. However, the same pixel surrounded by pixels of generally the same quality is not distracting. Thus, an important factor in ELD appearance is the homogeneity of the ELD pixels. By sorting and grouping EL strips 102 according to characteristics, relatively homogeneous collections of EL strips 102 are compiled. A manufacturer can then use EL strips 102 from a homogeneous group to produce an ELD, thereby enhancing overall ELD appearance and performance.

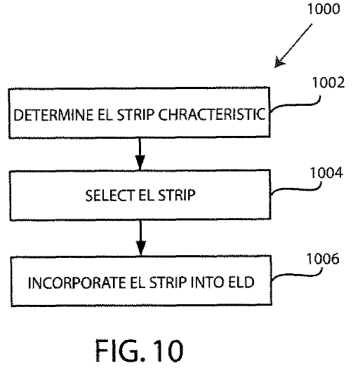

One exemplary method of producing an EL strip-based ELD is shown by method 1000 in FIG. 10. At block 1002, at least one EL strip characteristic is determined. For example, electrical and/or mechanical attributes can be used to characterize an EL strip 102, and provide a basis for selecting an EL strip 102 to produce an ELD for a particular application. At block 1004, an EL strip 102 satisfying the designated one or more characteristics is selected from a quantity of EL strips 102. EL strips 102 can be maintained in homogeneous groups, so that an EL strip 102 satisfying the designated requirements can easily be located and retrieved. At block 1006, the retrieved EL strip 102 is incorporated into an ELD structure.

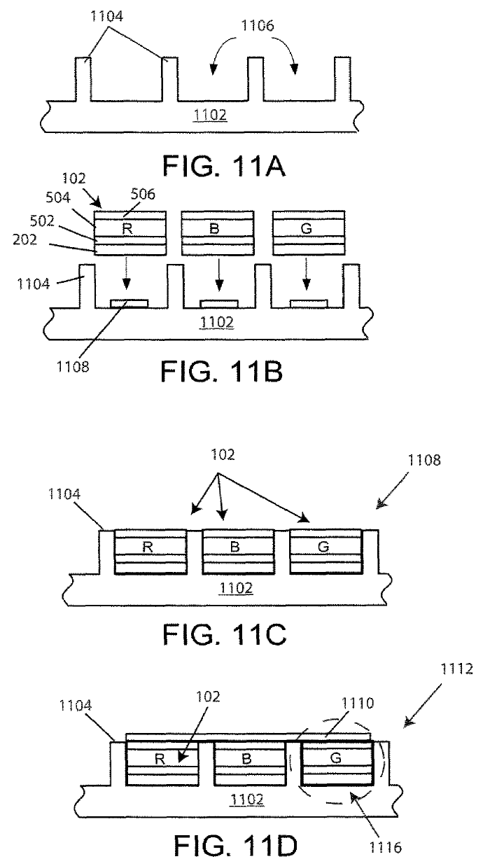

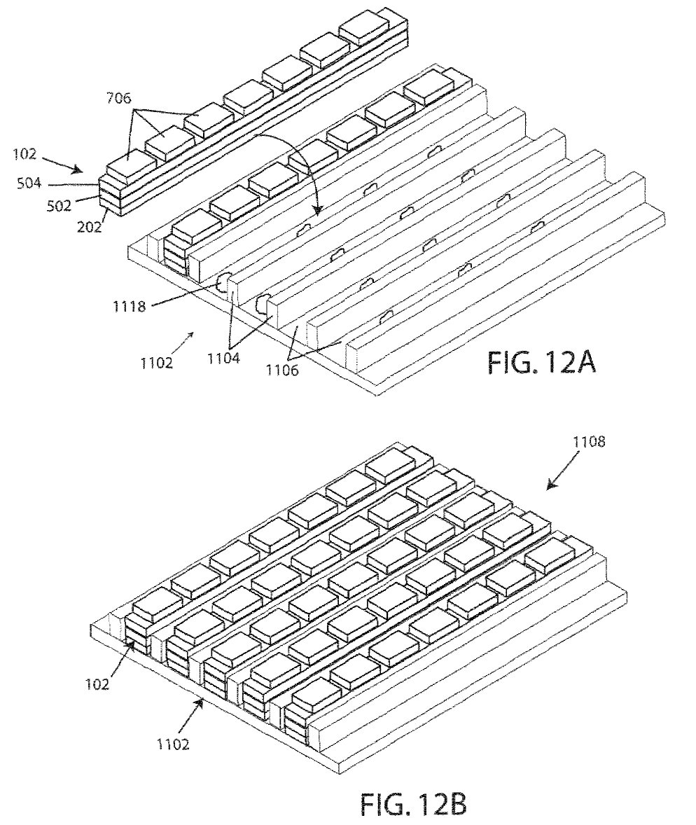

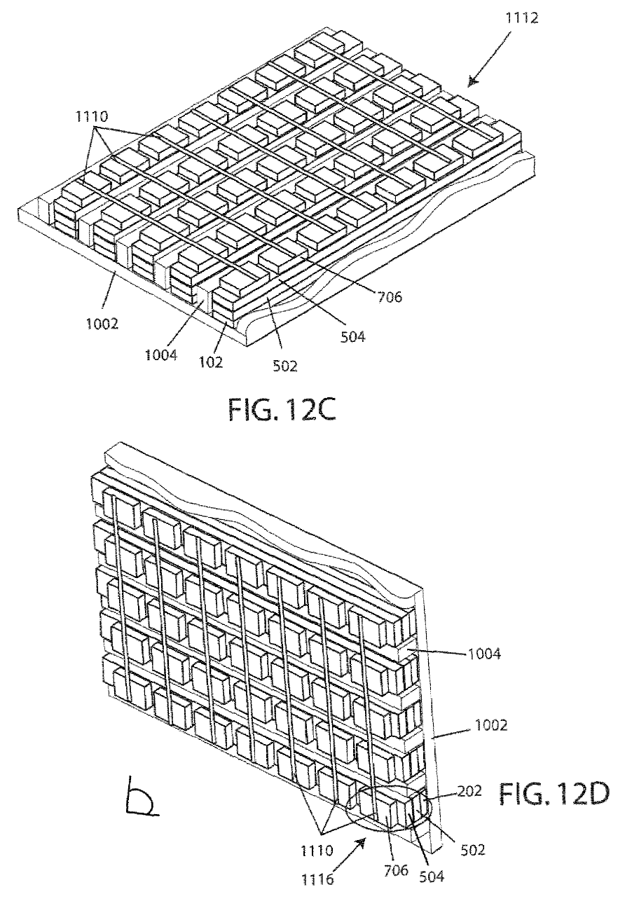

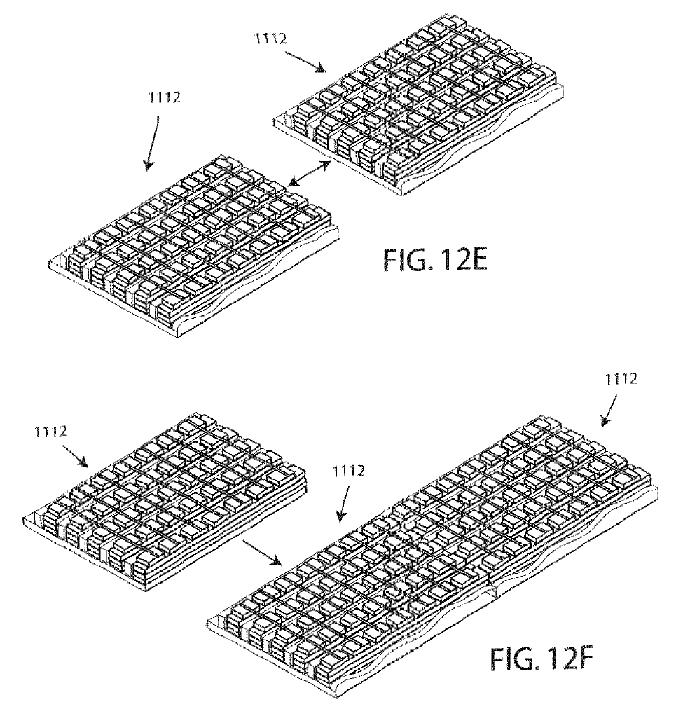

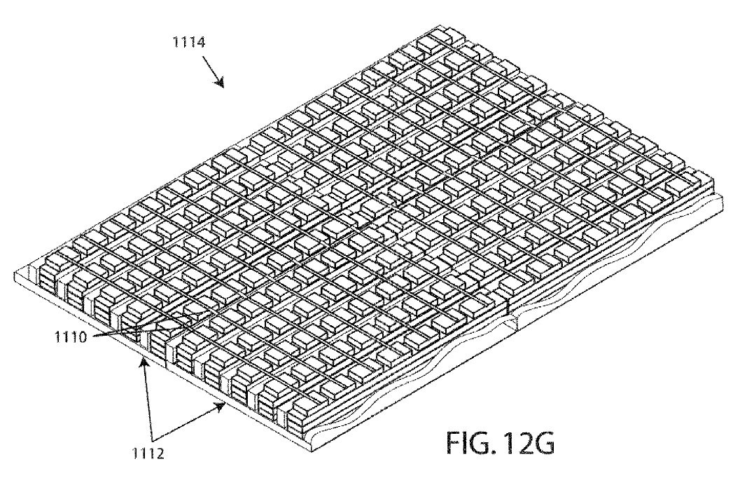

Once an EL strip 102 has been made, and, if desired, tested, it may be incorporated into a display. An exemplary method of incorporating an EL strip 102 into a display is shown in FIGS. 11A-11D and 12A-12G. As shown in FIGS. 11A and 12A, a flexible support 1102 is provided which has a plurality of spaced-apart raised extensions 1104, the spaces between the extensions 1104 defining channels 1106 that are adapted to receive the EL strips 102. In an exemplary embodiment, the flexible support 1102 is a polymer sheet. As shown in FIGS. 11B and 12A, EL strips 102 may be prepared separately and provided for insertion into the channel 1104. The EL strips 102 may include one phosphor so that they emit the same color of light or different phosphors so that they emit different colored light. To assist in the retention of the EL strips 102 to the flexible support 1102 an adhesive 1108 may be provided to the EL strips 102 or to the flexible support 1102 to adhere the EL strips 102 to the flexible support 1102 (FIGS. 11C and 12B). The grouping of the EL strips 102 forms an EL strip panel 1108.

As shown in FIGS. 11D and 12C the top electrode chips 706 of adjacent EL strips 102 may be aligned to form columns which may be electrically connected by a conductor connector 1110 and serve as column electrodes. The connection of the top electrode chips 706 to the EL strips 102 forms an EL panel 1112 which may be used as an EL display in itself or connected with other EL panels 1112 (FIGS. 12E and 12F) to form an enlarged display 1114 (FIG. 12G). As shown in FIGS. 11D and 12D the overlap of the row electrode formed by the SES 202 and the column electrode formed by the transparent electrode chip 706 defines a pixel 1116 of the EL panel 1112 which may be illuminated when a sufficient voltage is applied between the overlapping row and column electrodes.

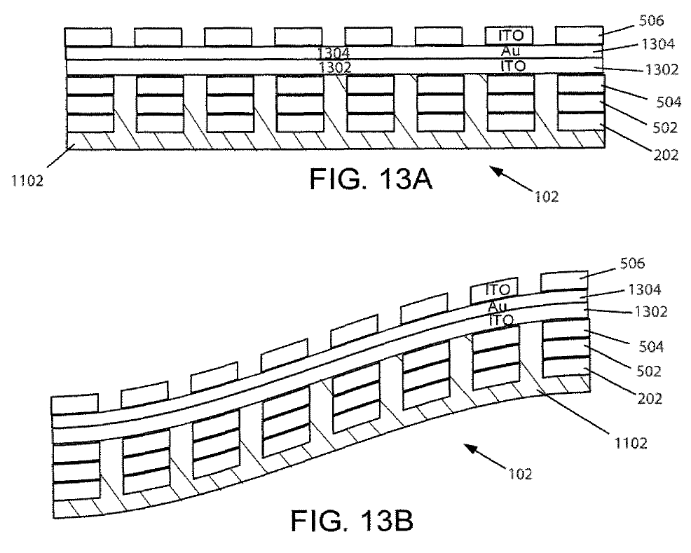

The conductor connector 1110 may be made of a variety of materials. Preferably the conductor connector 1110 is flexible so as to allow for connectivity between the top electrode chips 706 when the EL panel 1112 is flexed, and it may be transparent to allow for the passage of light emitted from the phosphor layer 504. As shown in FIG. 13A, a thin ITO layer 1302 may be provided on top of the phosphor layer 504. The conductor connector 1110 in the form of a gold strip 1304, or other conductive material, and the ITO layer 506 can be provided atop the thin ITO layer 1302 to form an EL strip 102. This allows the EL strip 102 to flex as shown in FIG. 13B without breaking the then ITO layer 1302. The upper ITO layer 506 may be thicker than thin ITO layer 1302 and provided in discrete portions.

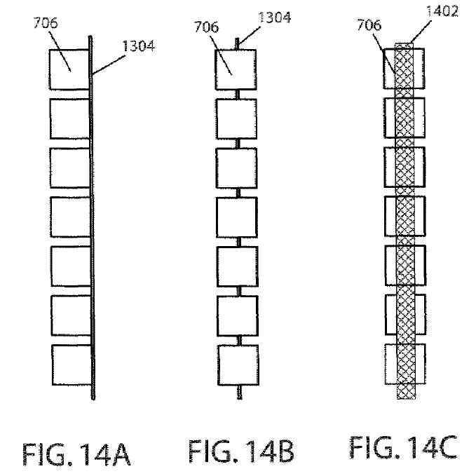

The conductor connector 1110 may take a variety of forms and several exemplary embodiments are shown in FIGS. 14A-14C. It is contemplated that the connecting conductor 1110 need not cover the entire surface of the ITO layer 506. FIG. 14A shows an example of a flexible conductor connector 1110 in the form of a transparent gold strip 1304, having a thickness of about 10 nm, adjacent to the electrode chips 706 that electrically connects the ITO electrode chips 706 together in a column. FIG. 14B shows an exemplary embodiment in which the conductor connector 1110 is a gold strip 1304 that extends under the middle of the ITO electrode chips 706. As shown in FIG. 14C, the conductor connector may be a conductive mesh 1402 that extends over a surface of the ITO electrode chips 706. The mesh 1402 allows for conductivity while allowing emitted light through the mesh 1402. Other configurations of the conductor connector 1110 will become apparent to one of skill in the art. For example, it is contemplated that the conductor connector 1110 may extend over, under, or next to the ITO blocks and may include a variety of patterns, and may be of a variety of flexible conducting materials such as a transparent conductive polymer or transparent conductive tape.

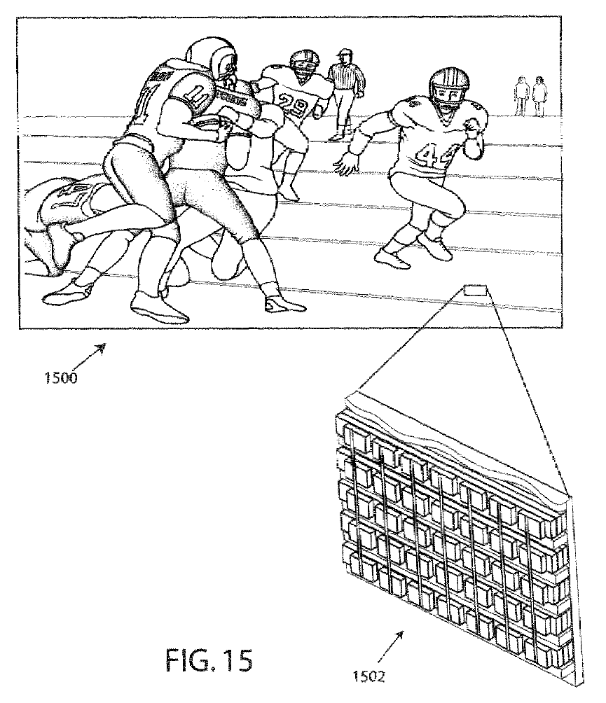

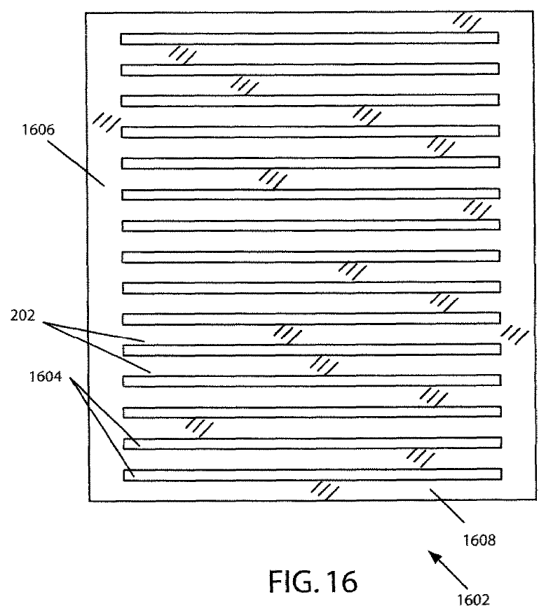

FIG. 15 shows an exemplary embodiment of a display 1500 which incorporates a plurality of EL panels 1502 wherein the EL panel 1502 can include a plurality of EL strips 102 that can serve as column and row drivers of a display. Referring to FIG. 16, a Supportive Electrode Unit (SEU) 1602 provides a means of manufacturing a plurality of EL strips 102.

FIG. 16 shows an exemplary embodiment of an SEU 1602 in the form of a molybdenum sheet having a plurality of spaced apart SESs 202 separated by elongated spaces 1604. The molybdenum sheet may be 3 mil thick and chemically etched to provide the desired array of SESs 202. In an exemplary embodiment, the SESs 202 have a length (depends on display) and width of 1 mm with gaps of 0.24 mm width. Support tabs 1606 can be provided at the ends of the SESs 202 to provide support and assist in keeping the SESs 202 in a desired position during manufacturing. As explained in more detail below, the support tabs 1606 may be removed during manufacturing so that the SESs 202 of different EL strip panels 1108 may be joined to form an EL display 1114. Support tabs 1608 may also be provided at the top and bottom edges of the rows 202 for additional support.

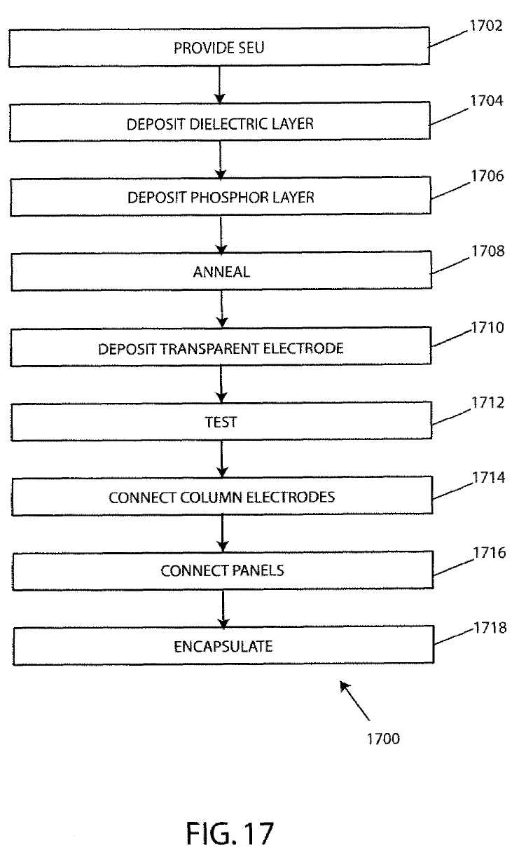

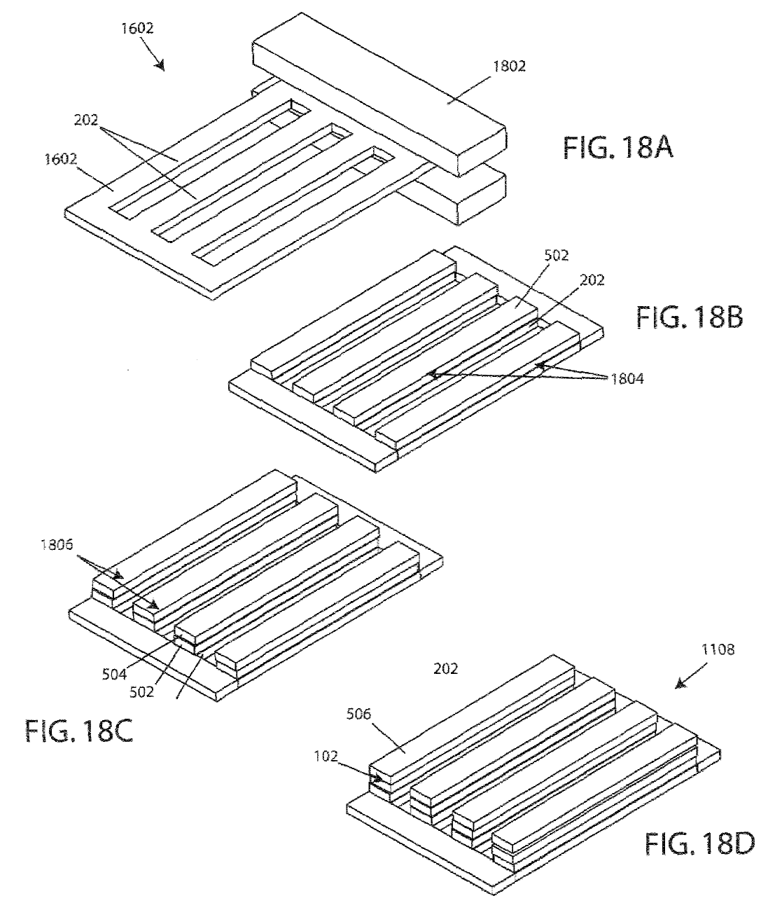

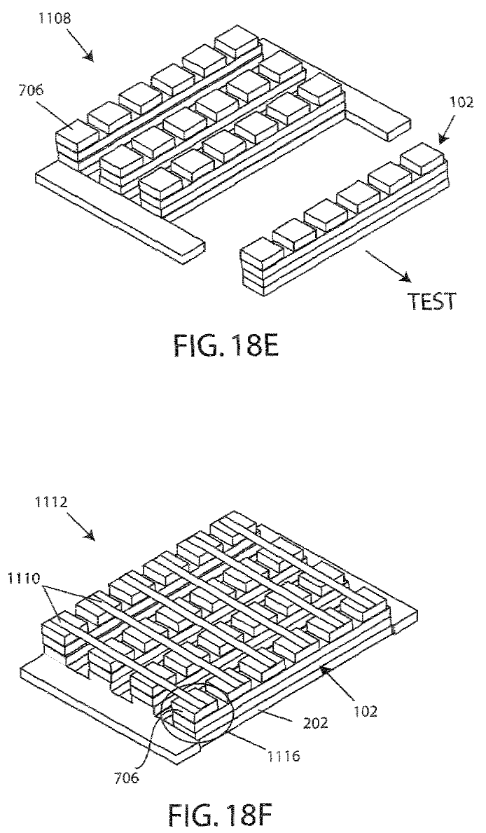

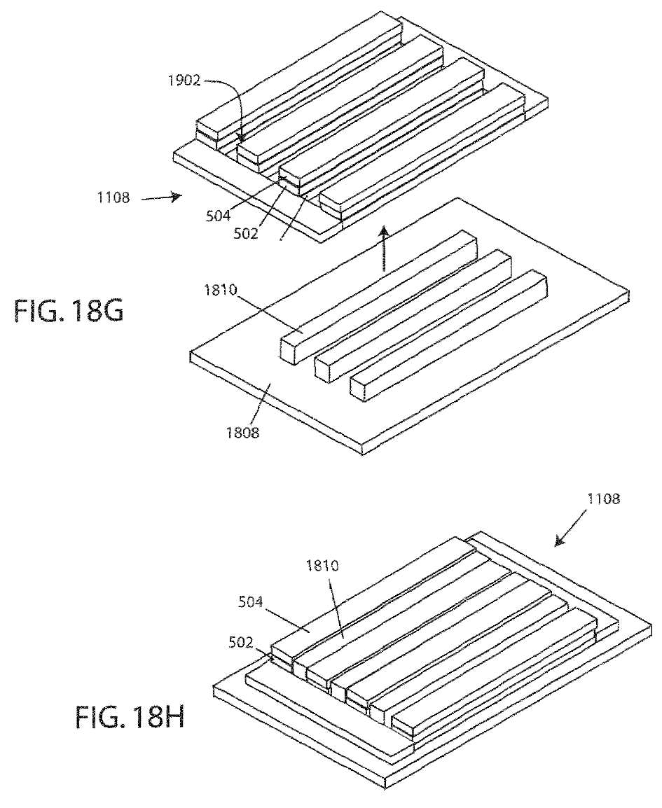

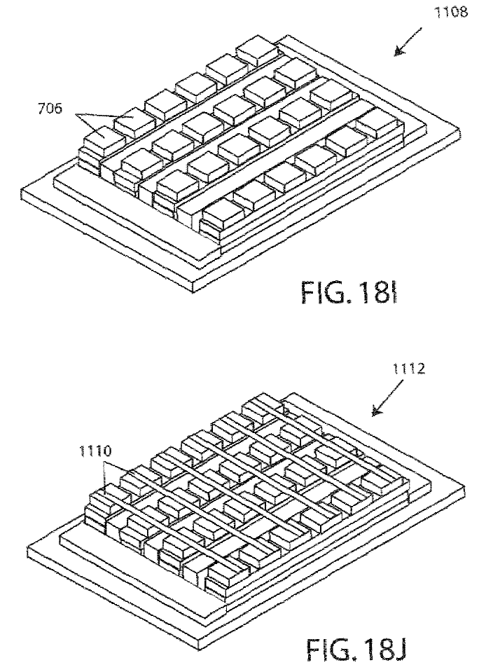

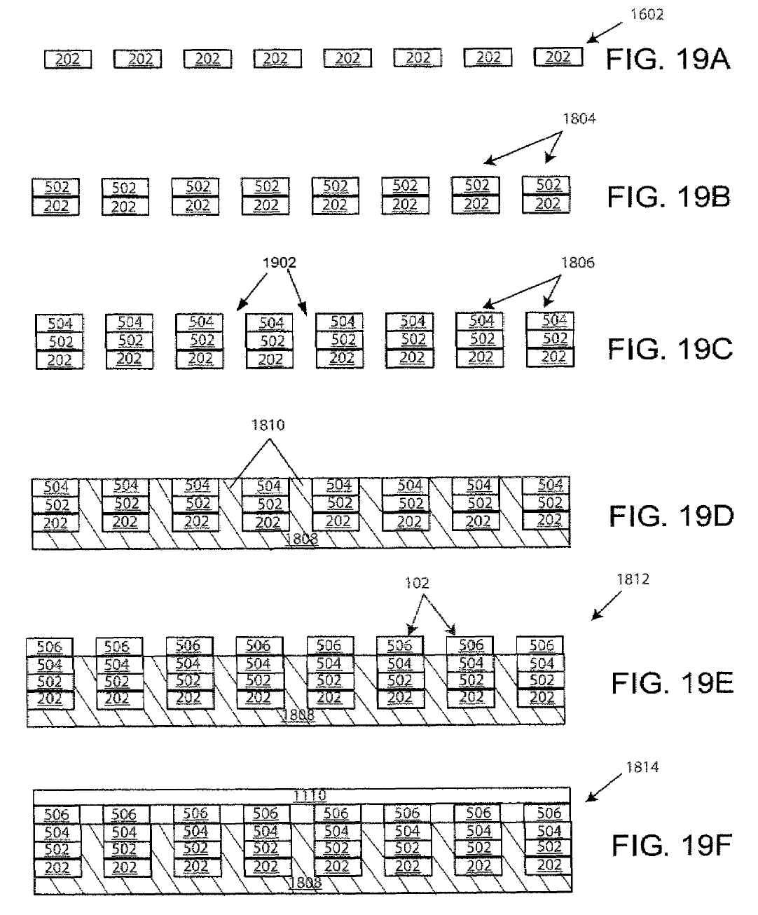

FIG. 17 shows a method 1700 for making a flexible EL display in accordance with an exemplary embodiment of the invention in which an SEU 1602 is used. At block 1702 an SEU 1602 is provided. As shown in FIG. 18A, the SEU 1602 may be placed in a holding device 1802 to assist in keeping the SESs 202 in a desired position for deposition of an EL stack 204 on the SESs 202 to form EL strips 102. At block 1704 a dielectric layer 502 is deposited atop the SES 202 of the SEU 1602 to produce the stacks 1804 shown in FIG. 18B and 19B. As discussed above, a layer of BaTiO₃ may be sputtered to a thickness of about 2 μm. As also discussed above other thin film dielectrics may be used such as RF magnetron sputtering using mixed powder targets.

At block 1706 a phosphor layer 504 is deposited on the dielectric layer 502 to produce the stacks 1806 shown in FIG. 18C and 19C. In an exemplary embodiment, the phosphor layer 504 is deposited by sputtering. In this example, a moisture resistant phosphor is used. This may be effected by a 2″ US gun at a substrate temperature between 200-250° C. in an atmosphere of 10% O₂ in argon and a pressure of 10 mTorr. The substrate holding device may be rotated in a planetary motion so that a film thickness variation of less than 10% is achieved. The phosphor film may be deposited to a thickness of about 4000-8000 Å.

At block 1708 the deposited films may be annealed. In an exemplary embodiment annealing takes place in air at 600° C. to 950° C. for one hour. Without the presence of a glass substrate, the stack 1806 can withstand the annealing temperature without deformation or breakdown. When the high temperature processing is completed, additional lower temperature processing may be performed.

As shown in FIGS. 18G and 19D a flexible support sheet 1808 may be inserted. The support sheet 1808 may be a polymer and be used to provide additional support to the stack 1806 and provide a foundation for laying a conductive layer 506. Referring to FIGS 18G-18I and 19C-19D, the gaps 1902 between the stacks 1806 may be filled by extensions 1810 of the support sheet 1808. The support sheet 1808 may be heated to assist its insertion. It is contemplated that the polymer may be colored to enhance the viewing characteristics of the display. For example, the support sheet may be black in order to increase the contrast ratio with the light emitted from the phosphor layer 504.

At block 1710 a transparent electrode layer 506 may be deposited on the phosphor layer 504 to form a plurality of EL stacks 102 that together define an EL panel 1812 as shown in FIGS. 18D, and 19E. As shown In FIGS. 18E and 18I the electrode layer 506 may be provided as discrete chips 706. In an exemplary embodiment a transparent indium tin oxide (ITO) top electrode layer 506 of about 2000 Å is deposited by sputtering.

The SEU 1602 with a plurality of completed EL strips 102 defines an EL strip panel 1812 as shown in FIG. 18D, 18I, and 19E. The EL strips 102 may be tested at block 1712. An individual EL strip 102 can be tested by applying a voltage between the top electrode 506 and the SES 202. If desired, an EL strip 102 can be separated from the SEU 1602 (FIG. 18E), for example by using a laser, and tested and/or incorporated into a display.

At block 1714 the transparent electrode layers 506 of the EL strips 102 on the EL strip panel 1812 can be electrically connected to form an EL panel 1112 as shown in FIGS. 14F and FIG. 18F, wherein the connected electrode layers 506 or electrode chips 706 can function as column drivers for the EL panel 1112. For example, a conductor connector 1110 can be used to connect the electrode chips 706 as shown in FIGS. 18F and 19F. The crossover of the SES 202 and the conductor chips 706 defines a pixel 1116 of the EL panel 1112, which can be tested by providing a sufficient voltage to induce EL.

Thus, the present invention allows for testing of EL strips 102, EL strip panels 1108, and EL panels 1112 prior to their incorporation into an EL display. If an EL strip 102, EL strip panel 1108, or EL panel 1112 is defective it may be repaired or discarded. This method is especially valuable when multiple EL panels 1112 will be incorporated into a larger display, thereby assuring that the larger display is not defective, the repair of which would be quite expensive.

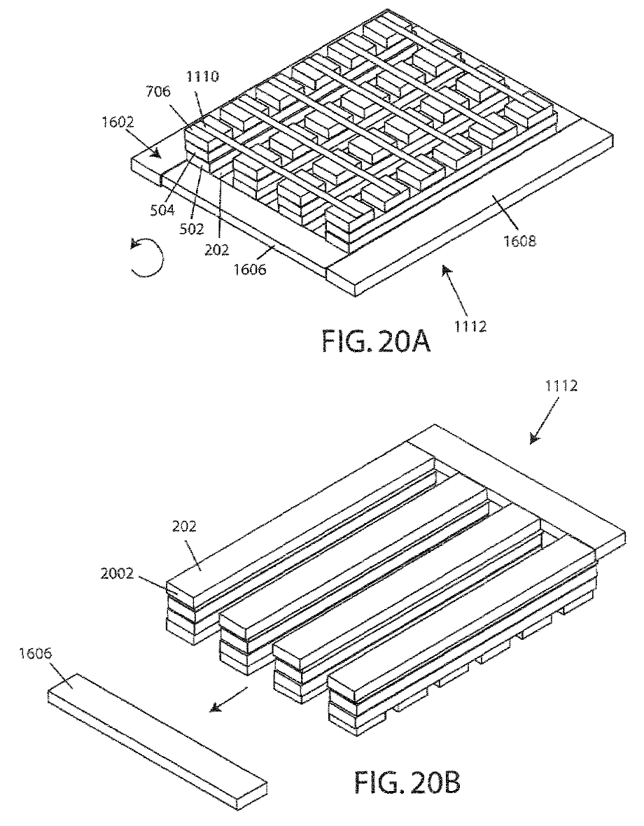

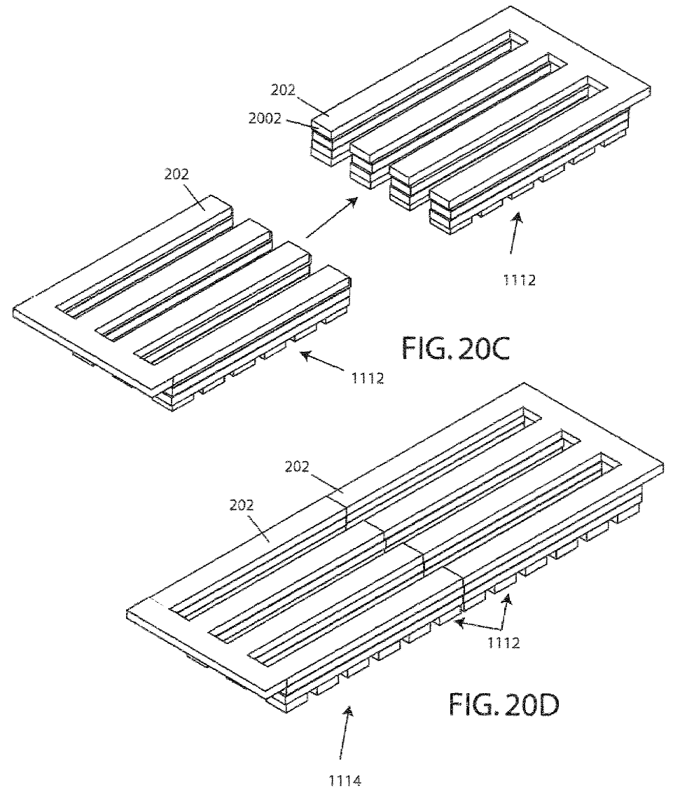

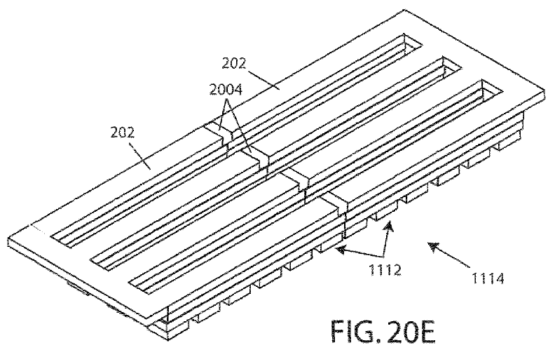

At block 1716 the EL panels 1112 may be joined to form an enlarged flexible display. FIGS. 20A-20E show an exemplary method of forming an EL display from multiple EL panels 1112. For clarity the EL panel 1112 is shown without the support 1808 but it is contemplated a similar procedure could be used with the support. Furthermore, in the EL panel 1112 shown, the conductor chips 706 have been connected by a conductor connector 1110. It is contemplated however that a similar process could be performed to incorporate EL strip panels 1812 into a display where the electrode chips 706 are electrically connected after connection of the EL strip panels 1108. The EL panel 1112 may be rotated bottom up and the support tabs 1606 removed from one end of the EL panel 1112 to expose the ends 2002 of the SESs 202 for connection with the SESs 202 of a second EL panel 1112. The support tabs 1606 may be removed by a variety of methods such as by a laser.

As shown in FIG. 20C, two EL panels 1112 with exposed SES ends 2002 may be positioned so that the SES ends are aligned and then placed together to that the SES ends 2002 abut as shown in FIG. 20D so that the SESs 202 are electrically connected. This alignment may be accomplished by optical sensors or other means known in the art. Once aligned, the display units 1112 may be welded together using solder tape 2004 (FIG. 20E) to form an elongated EL panel 2006. In the same manner additional EL panels 1112 may be added to form a continuous flexible EL display of a desired length. The elongated EL panel 2006 may be encapsulated in a protective coating such as an optically transparent polymer such as polypropylene or the like to protect the device. It should be noted that in a similar manner EL panels 1112 may be joined so that the transparent electrode chips 706 may be electrically connected with the transparent electrode chips 706 of another EL panel to form column drivers of an elongated display as described above with regard to FIG. 12E.

After a plurality of EL panels 1112 are joined to form an EL Display 1114 at block 1718 of FIG. 17 the EL display 1114 may be encapsulated. In an exemplary embodiment a flexible transparent polymer is used so that the EL display is flexible to allow the display to be folded, rolled, or otherwise flexed. It is contemplated that the portion of the cover positioned over the viewing portion of the display will be transparent and be provided with fresneling to focus the emitted light in a desired manner. For example, the cover could have a plurality of ridges to focus the emitted light to an area in front of the display.

In an exemplary embodiment, the transparent electrode layer of an EL strip is in the form of a plurality of electrode islands of a specified size in accordance with the desired pixel size of a display. The transparent electrode islands of the EL strips of an EL strip panel may be electrically connected to form an EL panel. In an exemplary embodiment a conductor connector is used to electrically connect the electrode islands to form column electrodes.

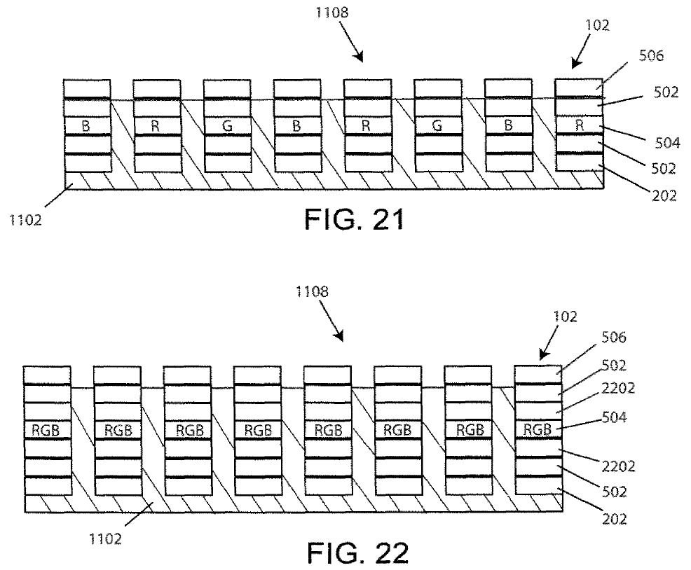

While in the embodiments discussed above the EL strips 102 generally comprised an SES 202, a dielectric layer 502, a phosphor layer 504, and a transparent electrode 506 it is contemplated that other or additional layers could be provided such as such as an additional electrode, dielectric, or phosphor layers. For example, FIG. 21 shows an exemplary embodiment of an EL strip panel 1108 having EL strips 201 in which an additional dielectric 502 is provided so that there is a dielectric layer 502 on each side of the phosphor layer 504. As previously mentioned, the dielectric layers 502 may be any of a variety of dielectric layers. FIG. 22 shows another exemplary embodiment of an EL strip panel 1108 in which the EL strips 2201 include dielectric charge injection layers 2202 are provided which provide enhanced electron injection into the phosphor layer 504 and an additional degree of robustness. In an exemplary embodiment the charge injection layers are in the form of Al₂O₃ sputtered on each side of the phosphor layer 504.

It will be appreciated that while the fabrication of the electroluminescent phosphors disclosed herein has been described using sputtering as the film deposition method, other methods known to those skilled in the art may be used, including electron beam deposition, laser ablation, chemical vapor deposition, vacuum evaporation, molecular beam epitaxy, sol gel deposition and plasma enhanced vacuum evaporation to mention a few. As shown in FIGS. 21 and 22 it is contemplated that EL strips 102 may include one or more phosphors of different colors, shown as R, G, and B to represent red, blue, and green respectively. Additional colors may also be employed.

Again, the above-described and illustrated embodiments of the present invention are merely exemplary examples of implementations set forth for a clear understanding of the principles of the invention. Variations and modifications may be made to the above-described embodiments, and the embodiments may be combined, without departing from the scope of the following claims.

What is claimed is:

1. An electroluminescent strip, comprising:
a supportive electrode strip comprising a conductive substrate; and
at least one electroluminescent stack disposed on said supportive electrode strip, the electroluminescent stack comprising a first dielectric layer, a phosphor layer, and an electrode layer.

2. The electroluminescent strip of claim 1, wherein said conductive substrate comprises a conductive sheet.

3. The electroluminescent strip of claim 1, wherein said conductive substrate comprises a molybdenum sheet.

4. The electroluminescent strip of claim 1, wherein the conductive substrate comprises a material selected from the group consisting of Mo, Ni, Al, Ag, Au, and alloys thereof.

5. The electroluminescent strip of claim 1, wherein said supportive electrode strip has a surface roughness of less than about 10 nm.

6. The electroluminescent strip of claim 1, wherein said phosphor layer comprises an open air phosphor.

7. The electroluminescent strip of claim 1, wherein said phosphor layer comprises at least two different phosphors.

8. The electroluminescent strip of claim 1 wherein said phosphor layer comprises a blue-emitting phosphor, a green-emitting phosphor, a red-emitting phosphor, or a combination thereof.

9. The electroluminescent strip of claim 1, wherein said phosphor layer comprises BaAl₂S₄:Eu, SrS:Cu, Zn₂Si_{0.5}Ge_{0.5}O₄:Mn, ZnS:Mn, Ga₂O₃:Eu, or combinations thereof.

10. The electroluminescent strip of claim 1, wherein said electrode layer comprises a transparent electrode.

11. The electroluminescent strip of claim 1, wherein said electrode layer comprises indium tin oxide.

12. The electroluminescent strip of claim 1, wherein said electrode layer comprises a plurality of electrode islands.

13. The electroluminescent strip of claim 1, wherein said EL stack further comprises a second dielectric layer.

14. The electroluminescent strip of claim 1, wherein said first dielectric layer comprises BaTiO₃.

15. The electroluminescent strip of claim 1 wherein said first dielectric layer comprises SiO₂, SiON, Al₂O₃, BaTiO₃, BaTa₂O₆, SrTiO₃, PbTiO₃, PbNb₂O₆, Sm₂O₃, Ta₂O₅—TiO₂, Y₂O₃, Si₃N₄, SiAlON, or combinations thereof.

16. The electroluminescent strip of claim 1, wherein said electroluminescent stack further comprises a charge injection layer and a second dielectric layer.

17. The electroluminescent strip of claim 1, wherein said electroluminescent stack further comprises a first charge injection layer, a second dielectric layer, and a second charge injection layer.

18. The electroluminescent strip of claim 1, wherein said electroluminescent strip is adapted to produce electroluminescence when a voltage is applied to said electroluminescent strip.

19. The electroluminescent strip of claim 1, wherein said supportive electrode strip is flexible.

20. The electroluminescent strip of claim 1, wherein said electroluminescent strip is flexible.

21. An electroluminescent strip panel comprising a plurality of connected electroluminescent strips as in claim 1.

22. The electroluminescent strip panel of claim 21 further comprising a support structure, wherein said plurality of electroluminescent strips are connected to the support structure.

23. The electroluminescent strip panel of claim 21, wherein the electrode layer of each electroluminescent stack has a plurality of electrode chips and wherein said electroluminescent strips are aligned to form a column/row electrode.

24. The electroluminescent strip panel of claim 21 wherein the electrode of each electroluminescent strip is a transparent electrode, and said electroluminescent strips are arranged so that said transparent electrode defines a first column/row electrode and said supportive electrode strips of said electroluminescent strips define second row/column electrodes of the apparatus.

25. An electroluminescent strip panel as in claim 21 wherein the plurality of electroluminescent strips are electrically connected.

26. An electroluminescent display comprising a plurality of connected electroluminescent strip panels as in claim 21.

27. A flexible electroluminescent display comprising at least one electroluminescent strip panel as in claim 21, wherein the at least one electroluminescent strip panel is flexible.

28. A flexible electroluminescent display comprising a plurality of electroluminescent strip panels as in claim 21, wherein the plurality of electroluminescent strip panels are flexible.

29. An electroluminescent display, comprising:
a supportive electrode unit comprising a plurality of supportive electrode strips, each supportive electrode strip comprising a conductive substrate; and
at least one electroluminescent stack deposited on each of said supportive electrode strips, each electroluminescent stack electrically connected and comprising a dielectric layer, a phosphor layer, and an electrode layer.

30. A method for making an electroluminescent strip comprising:
providing a supportive electrode strip comprising a conductive substrate; and
depositing at least one electroluminescent stack on said supportive electrode strip, the at least one electroluminescent stack comprising a dielectric layer, a phosphor layer, and an electrode layer.

31. The method of 30, wherein said conductive substrate comprises a conductive sheet adapted to receive said electroluminescent stack.

32. A method for making a display comprising connecting a plurality of electroluminescent strips, each electroluminescent strip comprising a supportive electrode strip comprising a conductive substrate and at least one electroluminescent stack disposed on said supportive electrode strip, the electroluminescent stack comprising a dielectric layer, a phosphor layer, and an electrode layer.

33. The method of claim 32, further comprising testing at least one of said plurality of electroluminescent strips before the at least one of said plurality of electroluminescent strips is connected to determine if the at least one of said plurality of electroluminescent strips is defective.

34. The method of claim 33, further comprising sorting or classifying said at least one of said plurality of electroluminescent strips.

35. The method of claim 33 wherein said testing comprises applying a voltage to said at least one of the plurality of electroluminescent strips to induce electroluminescence.

36. The method of claim 33, wherein said testing said electroluminescent strip comprises:
applying a voltage to said electroluminescent strip to induce electroluminescent; and
observing at least one characteristic of said electroluminescent strip.

37. The method of claim 33, further comprising incorporating said electroluminescent strip into a display in accordance with said testing.

38. The method of claim 32 wherein the step of connecting the plurality of electroluminescent strips forms an electroluminescent strip panel.

39. The method of claim 38, wherein connecting a plurality of electroluminescent strips to form an electroluminescent strip panel comprises connecting said plurality of electroluminescent strips to a support structure.

40. A method, comprising:
providing a supportive electrode unit, said supportive electrode unit comprising a plurality of supportive electrode strips and each supportive electrode strip comprising a conductive substrate; and
depositing at least one electroluminescent stack on each supportive electrode strips to form a grouping of electroluminescent strips, said electroluminescent strip grouping defining an electroluminescent strip panel and each electroluminescent stack comprising a dielectric layer, a phosphor layer, and an electrode layer.

41. The method of claim 40, further comprising incorporating said electroluminescent strip panel into a display.

42. The method of claim 40, further comprising removing one of said electroluminescent strips from said electroluminescent strip panel.

43. The method of claim 42, further comprising reincorporating said removed electroluminescent strip into the display.

44. A method, comprising:
depositing a first dielectric layer atop a supportive electrode strip comprising a conductive substrate;
depositing a phosphor layer atop said dielectric layer; and
depositing an electrode layer atop said phosphor layer, wherein said supportive electrode strip, said first dielectric layer, said phosphor layer, and said electrode layer form an electroluminescent strip.

45. The method of claim 44, further comprising annealing said phosphor layer.

46. The method of claim 44, further comprising providing a second dielectric layer atop said phosphor layer.

47. The method of claim 44, further comprising depositing a charge injection layer atop said first dielectric layer.

48. The method of claim 44, further comprising incorporating said electroluminescent strip into a display.

49. The method of claim 44, further comprising connecting said electroluminescent strip to a flexible support sheet.

50. A method comprising:
connecting a plurality of electroluminescent strips to a support structure, each electroluminescent strip comprising a supportive electrode strip comprising a conductive substrate and at least one electroluminescent stack disposed on said supportive electrode strip, the electroluminescent stack comprising a dielectric layer, a phosphor layer, and an electrode layer; and
electrically connecting said electroluminescent strips to form an electroluminescent display.

51. The method of claim 50, wherein said electrically connecting said electroluminescent strips comprises electrically connecting an electrode layer of said electroluminescent strips.

52. The method of claim 50, further comprising joining a plurality of electroluminescent displays to form an aggregate display.

53. The method of claim 50 wherein said electrically connecting an electrode layer of said electroluminescent strips comprises connecting a conductor connector between said electrode layers.
